(19) United States
(12) Patent Application Publication
(10) Pub. No.: US 2015/0206147 A1
(43) Pub. Date: Jul. 23, 2015

(54) Dynamic Security Code

(71) Applicant: Intersections Inc., Chantilly, VA (US)

(72) Inventors: Michael Stanfield, The Plains, VA (US); Joseph Vacca, Lovettsville, VA (US); Dawn Kresslein, Dulles, VA (US)

(21) Appl. No.: 14/657,819

(22) Filed: Mar. 13, 2015

Related U.S. Application Data
(63) Continuation-in-part of application No. 14/065,192, filed on Oct. 28, 2013.
Application No. 14/065,192 is a continuation of application No. 12/732,349, filed on Mar. 26, 2010, now Pat. No. 8,567,670.
(60) Provisional application No. 61/952,734, filed on Mar. 13, 2014.
(60) Provisional application No. 62/017,817, filed on Jun. 26, 2014.
(60) Provisional application No. 61/163,972, filed on Mar. 27, 2009.
(60) Provisional application No. 61/308,493, filed on Feb. 26, 2010.

(51) Int. Cl. G06Q 20/40; G06Q 20/36

(52) U.S. Cl. CPC G06Q 20/4018; G06Q 20/3674

(57) ABSTRACT

A system and method for providing card verification values for card-not-present transactions is described. In one example, a user's computing device stores single-use CVVs to be provided from a secure wallet. The secure wallet may be software running on the user's computing device. Alternatively, it may be an external device connectable to the user's computing device, which accesses the external device to obtain the single-use CVV.

### CROSS-REFERENCE TO RELATED APPLICATIONS

This application claims priority to U.S. Provisional Application Nos. 61/952,734, filed Mar. 13, 2014, and 62/017,817, filed Jun. 26, 2014. Also, this application is a continuation-in-part of co-pending U.S. application Ser. No. 14/065,192, filed Oct. 28, 2013, which is a continuation of co-pending U.S. application Ser. No. 12/732,349, filed Mar. 26, 2010, which claims priority to U.S. provisional application Nos. 61/163,972, filed Mar. 27, 2009, and 61/308,493, filed Feb. 26, 2010. The contents of these applications are expressly incorporated herein by reference.

### RELATED ART

Credit card users are becoming increasingly aware of credit card fraud as identity theft and other crimes increase. While users may be able to prove to merchants and banks that they were not responsible for credit card charges and ultimately be not responsible for unauthorized charges, the hassle, lost opportunity costs, reduction in credit scores, and potential for long-term litigation can make credit card users wary of providing credit card information in-person or online.

Some credit card systems require authorization of the user and merchant. However, authorization of a given merchant is not protection that someone at the merchant (or someone monitoring a transaction) may abscond with a user's credit card number and associated verification information.

### SUMMARY

Aspects relate to increasing security for credit card transactions. In some aspects, a dynamic card verification value may be provided in a secure fashion to a merchant and/or user. These and other aspects are described below.

### BRIEF DESCRIPTION OF DRAWINGS

FIG. 1 shows a credit card account in accordance with one or more aspects of the disclosure.

FIG. 2 shows interactions between a card issuer and a user's computing device in accordance with one or more aspects of the present disclosure.

FIG. 3 shows interactions between a card issuer, a merchant, and a user's computing device in accordance with one or more aspects of the present disclosure.

FIG. 4 shows various pathways for secure and unsecured information as accessed through a user's computing device in accordance with one or more aspects of the present disclosure.

FIG. 5 shows various processes for obtaining credit card information in accordance with one or more aspects of the present disclosure.

FIG. 6 shows various processes for obtaining a card verification value in accordance with one or more aspects of the present disclosure.

FIG. 7 shows various examples for how to store multiple card verification values in accordance with one or more aspects of the present disclosure.

FIG. 8 shows a first card registration embodiment.

FIG. 9 shows a second card registration embodiment.

FIG. 10 shows a third card registration embodiment.

FIG. 11 shows registration of additional devices.

FIG. 12 shows a customer purchase embodiment in which a data connection is available between the cardholder and the card issuer.

FIG. 13 shows another customer purchase embodiment in which a data connection is available between the cardholder and the card issuer.

FIG. 14 shows a customer purchase embodiment in which a data connection is not available between the cardholder and the card issuer.

FIG. 15 shows an embodiment where the card issuer hosts a list of or an algorithm generating active dynamic security codes.

FIGS. 16-17 show an example of payment processing using a dynamic security code.

FIG. 18 shows a modification of the payment processing of FIG. 17 as using a transaction evaluator/scorer.

FIG. 19 shows another modification of the payment processing of FIG. 17 as including a DSC processor that manages the DSCs.

FIG. 20 shows an embodiment related to the payment handling of a dynamic security code of FIGS. 13 and 14.

FIG. 21 shows an embodiment related to the payment handling of a dynamic security code

FIG. 22 shows another embodiment related to the payment handling of a dynamic security code.

FIG. 23 shows a customer purchasing experience in which the dynamic security code is displayed to the customer/card holder.

FIG. 24 shows another customer purchasing experience in which the dynamic security code is displayed to the customer/card holder in which the dynamic security code varies by selected card.

FIG. 25 shows another customer purchasing experience in which the dynamic security code is displayed to the customer/card holder in which the dynamic security code varies by selected card.

### DETAILED DESCRIPTION

Aspects of the concepts described herein relate generally to providing a card verification value for credit card transactions.

It is noted that various connections are set forth between elements in the following description. It is noted that these connections in general and, unless specified otherwise, may be direct or indirect and that this specification is not intended to be limiting in this respect.

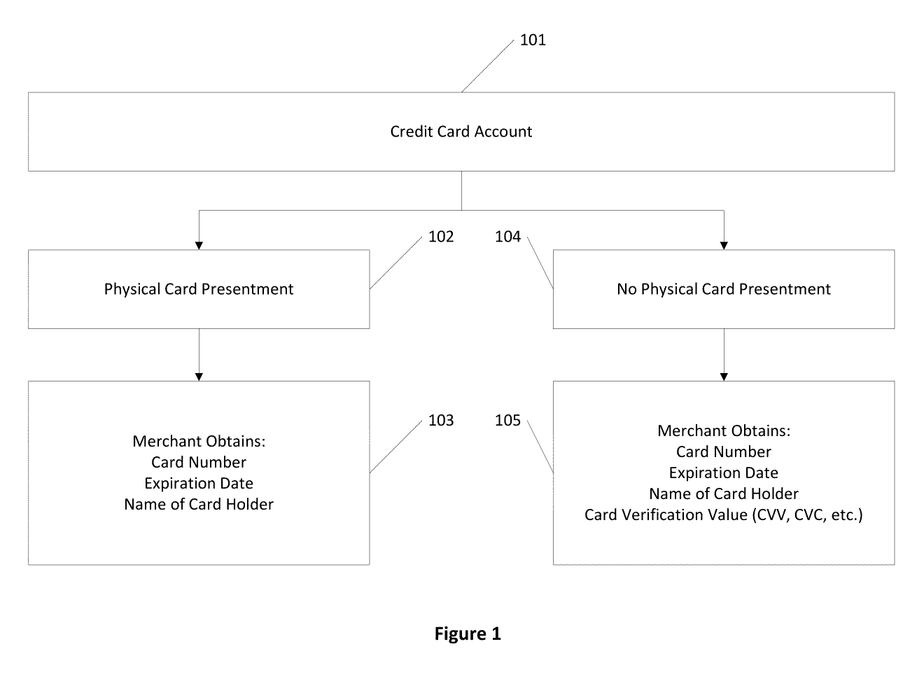

FIG. 1 shows a credit card account in accordance with one or more aspects. A card issuer may provide a cardholder with a credit card account 101. Credit card account 101 may include a one or more credit cards that may be used for in-person credit card transactions 102 and card-not-present credit card transactions 104. As used herein, card-not-present credit card transactions 104 may include online purchases, off-line form-based transactions (for instance, fax and paper mail-based transactions), recurring transactions, and the like.

In physical card presentment transactions 102, a merchant obtains a credit card number, expiration date, and the name of the cardholder in step 103 to verify the credit card and, if the merchant asks for additional identification, to verify the identity of the cardholder.

In card-not-present transactions 104, a merchant obtains the credit card number, expiration date, name of the cardholder, and a card verification value CVV of the card as a way of verifying that the cardholder has the physical card in possession. Card verification values are also referred to as CVV2, card security code CSC, card verification value code CVVC, verification code (V-code or V code), and card code verification CCV. For purposes of explanation, the term CVV is used for simplicity and is intended to cover the above card verification codes.

In some situations, in-person credit card transactions may be processed as card-not-present transactions when, for instance, a merchant's transaction terminal cannot read a magnetic strip on a user's card. If the merchant keys in the credit card number and the CVV of the card, that transaction may be processed as a card-not-present transaction as opposed to an in-person credit card transaction.

Both merchants and cardholders may be wary of each other in card-not-present transactions as, to the cardholder, these transactions may provide a greater degree of risk that the user's credit card information may be captured and used without authorization and as, to the merchant, these transactions may be based on illegally obtained credit card information. While the merchant may provide goods or services to the card user, the merchant may find out too late that the card transaction was fraudulent and the merchant is refused payment (or settlement) from the card issuer for the sold goods or services.

One or more aspects relate to providing enhanced security for card-not-present transactions by providing a dynamic card verification value to be used with a single transaction.

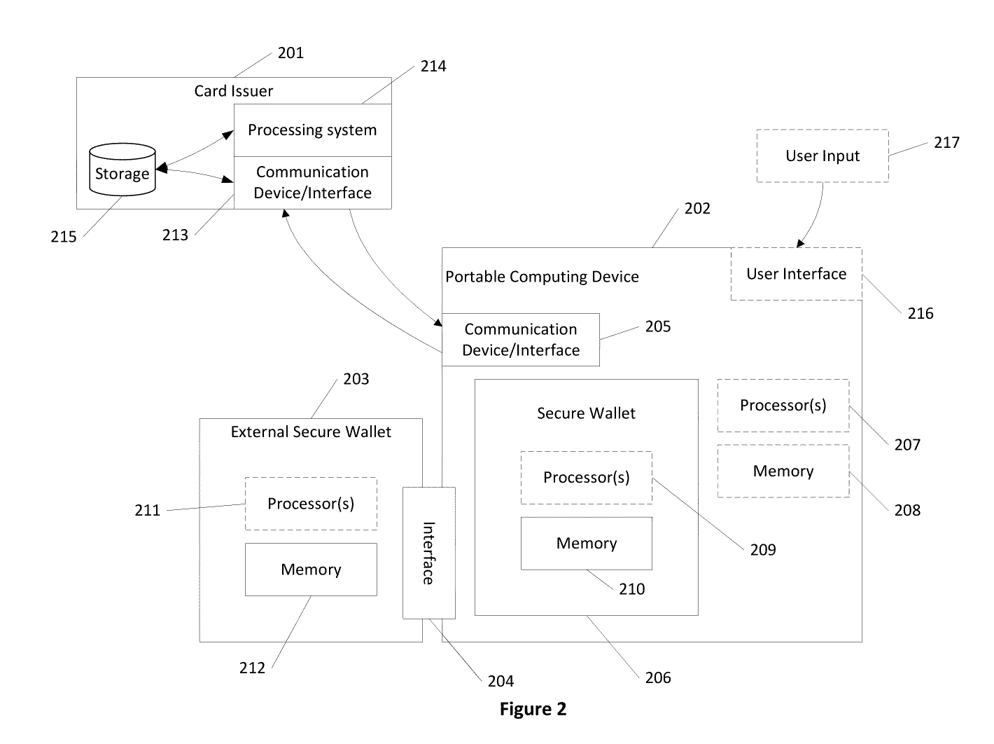

FIG. 2 shows interactions between a card issuer and a user's computing device in accordance with one or more aspects. FIG. 2 shows a card issuer 201 and a user's computing device 202. The user's portable computing device 202 may include a personal data assistant (PDA), Smart phone, or other portable computing device as known in the art. For instance, the user's computing device 202 may include a notebook computer, a cell phone with data capabilities, a handheld computing device with cellular capabilities, and the like. In another example, the user's computing device may also include a desktop computer, set top cable/satellite television box, gaming console, and other computing environments. In yet another example, the user may not own the computing device 202 but rather be only using the computing device 202 for a short period (for example, at an internet café).

Various examples and embodiments of the present invention are described with respect to one or more secure wallets. One of the wallets may be an external secure wallet 203. Another of the wallets may be an internal secure wallet 206. For purposes of explanation, both external wallet 203 and internal secure wallet 206 are described in the various embodiments. In some situations, external wallet 203 and internal secure wallet 206 may be used together or may be present to a user's portable computing device 202. It is appreciated, however, that only one of the wallets 203 or 206 may be present for use by a user. The wallets may be entirely encrypted software, firmware, hardware, or any combination thereof. For example, a secure processor requiring authentication before access may include various levels of encryption (e.g., using AES, Triple-DES, etc.). In one example, all data stored in a memory may be encrypted. In another example, only some of the information may be encrypted. Further, with respect to software, various functions may be embodied as software modules executed by a computer that control the computer to perform the functions. Examples of computer-readable media include hard drives, flash memory, other dynamic memory, and other static memory as known in the art.

External secure wallet 203 includes a memory 212 and an interface 204. External secure wallet 203 optionally includes one or more processors 211 to further enhance the security of the external secure wallet 203. For instance, the external secure wallet 203 may require various levels of authentication before it provides data to the user's computing device 202 via interface 204. For instance, external secure wallet 203 may be a flash memory device having a USB interface as interface 204. Similarly, external secure wallet 203 may be a variety of other external memory devices including, for instance, SD cards, Sony MEMORYSTICK™, external hard drives, key fobs, and the like, each with one or more varieties of interfaces 204. While processor 211 is not required to be present on external secure wallet 203, some card issuers 201 may find enhanced security through separate authentication and other encryption/decryption capabilities to be useful in protecting credit card information.

User's computing device 202 may include secure wallet 206 running as purely software or as a combination of software and hardware. For instance, internal secure wallet 206 may include secure memory 210 that requires authentication for access to the contents within memory 210. In another example, the secure wallet may include a processor 209 that controls access to memory 210. In a further example, the user's computing device may include one or more processors 207 and/or memory 208. In this further example, the user's computing device may permit unsecured operations to occur in processor 207 and memory 208 without needing to access secure wallet 206 and/or external secure wallet 203.

User's computing device 202 may include a user interface 213 to receive user input 214 from a user. User interface 213 may include, for example, a microphone and speaker (for voice authentication), a numeric keypad, a display with one or more fields, accelerometers, one or more cameras, and the like. In some examples, user interface 213 may capture biometric information (iris scan, fingerprint, voice authentication (mentioned above) to provide enhanced authentication features to the internal or external secure wallets. One or more of these items may be used to provide a level of authentication (or multiple levels of authentication) to permit user access to at least one of internal secure wallet 206 and external secure wallet 203. The input from the user interface 213 may be compared with locally stored information or remotely obtained information to determine if the user is the authorized user of the device. Further, for enhanced security, the input from the user interface 213 may be sent to a remote site (for example, to the card issuer or other remote entity) to authenticate the user as the authorized user.

User's computing device 202 may further include a communication device/interface 205 as embodied in hardware, software, or a combination. For instance, communication interface/device 205 may be a cellular telephone transceiver, a wireless network application device (for instance, WIFI™ or WiMAX™), Bluetooth, IR, and other wireless communication devices.

Communication device/interface 205 may permit user's computing device 202 to communicate with a communication device/interface 213 associated with card issuer 201. The communication pathway between the card issuer 201 and user's computing device 202 may be direct or indirect through one or more servers/routers/bridges/switches and the like. For instance, card issuer 201 and user's computing device 202 may be configured to indicate with each other over both cellular transmission systems as well as over the Internet via a WiFi connection.

Card issuer 201 may include a processing system 214 as known in the art (for instance, a server or farm of servers) and storage system 215 (for instance, large-scale database or cloud-based storage systems as known in the art).

In one or more aspects, card issuer 201 generates one or more card verification values that may be stored in at least one of external secure wallet 203 or internal secure wallet 206. Those generated dynamic CVVs may be associated with one or more expiration dates and/or windows in which the dynamic CVVs are valid. For purposes herein, the dynamic CVVs are also referred to as dynamic security codes (“DSCs”).

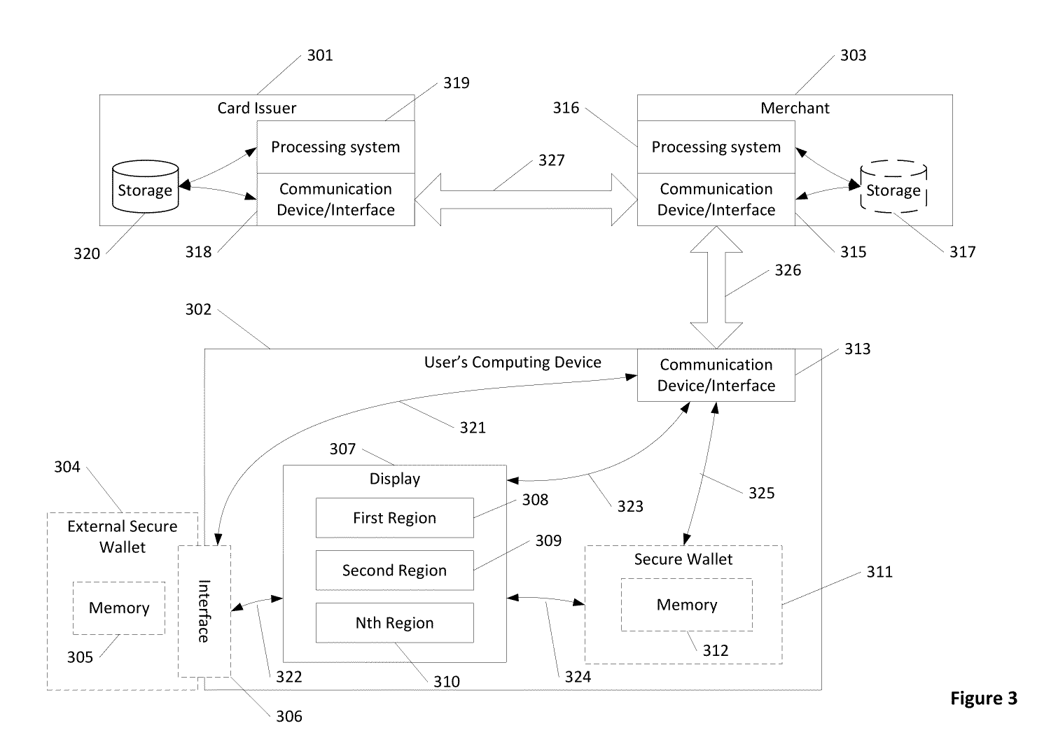

FIG. 3 shows interactions between a card issuer, a merchant, and a user's computing device in accordance with one or more aspects. FIG. 3 shows various examples of how a merchant maintain credit card information from a user can process that information with a card issuer. Here, card issuer 301, a user's computing device 302, and a merchant 303 are described for handling card-not-present transactions (and/or transactions requiring a CVV).

The user's computing device 302 may include one or more components similar to that of user's computing device 202 of FIG. 2. For aid of explanation, various optional components are shown in broken lines. For instance, user's computing device 302 may include external secure wallet 304 with a memory 305 (and optionally a processor, not shown), interface 306, and internal secure wallet 311 with memory 312 (and optionally a processor, not shown). In FIG. 3, user's computing device 302 includes a display 307 with at least one region in which to display information to a user. Here, three regions are shown for reference (first region 308, second region 309, and Nth region 310). Five internal communication paths are shown within user's computing device 302. It is appreciated that not all of these communication paths will exist in all computing devices 302 as based on the existence of various components. It is appreciated that the “paths” may be actually represented in dedicated hardware (for example, specific buses) in the user's computing device 302 or may be functional in nature (as being sent on one or more system buses or subsystem buses with appropriate headers).

A first path 321 is shown from interface 306 to communication device/interface 313. This first path is the most secure by permitting completely encrypted credit card information and CVVs to be sent to communication device/interface 313.

A second path 322 is shown from interface 306 to display 307. This second path 322 may be used to provide acknowledgment content or information signifying secure content (for instance, a stream of asterisks).

A third path 324 may be provided from internal secure wallet 311 to display 307. This path may be used to forward credit card information and a CVV to a user for display in display 307.

The user may write down or manually copy the displayed credit card information and CVV to credit card information entry fields from a merchant (for example, to a merchant's downloaded page from the Internet, from another network, or into paper documents for subsequent credit card transactions) via a fourth path 323.

A fifth path 325 permits the credit card information and CVV to be transferred directly from internal secure wallet 311 to the merchant 303 via interface 313. In this example, the fifth path 325 may be used to allow internal secure wallet 311 to populate fields on a displayed user interface as relating to a merchant's webpage to minimize errors in attempts to prevent theft of the credit card information and CVV by minimizing content displayed in display 307.

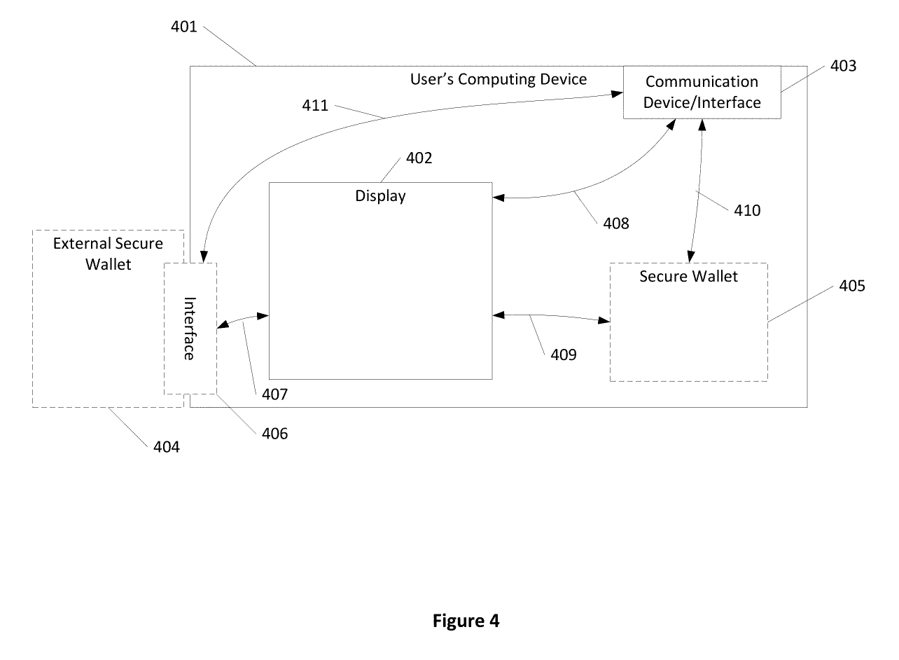

FIG. 4 shows a user's computing device 401 with pathways similar to those of FIG. 3. In FIG. 4, user's computing device 401 includes display 402, communication device/interface 403, and may include external secure wallet 404, interface 406, internal secure wallet 405, a first path 411 linking interface 406 and communication device/interface 403, a second path 407 linking interface 406 and display 402, a third path 409 linking internal secure wallet 405 and display 402, a fourth path 408 linking display 402 and communication device/interface 403, and a fifth path 410 linking internal secure wallet 405 and communication device/interface 403.

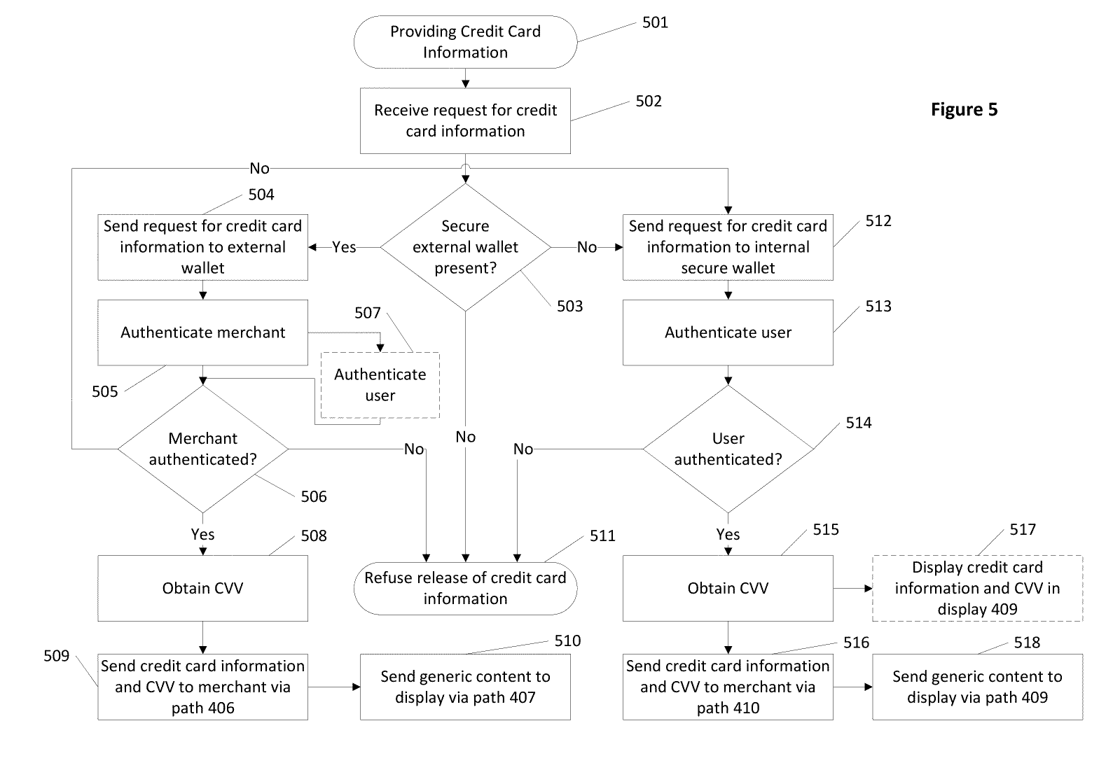

FIG. 5 illustrates various processes for providing credit card information using the pathways of FIG. 4. In step 501, a user desires to provide credit card information to a merchant. In step 502, the user's computing device 401 receives a request from the user to provide credit card information in a form usable by a merchant (for instance, electronically to be transmitted to the merchant or displayed to a user who can forward the information to a merchant). In step 503, the user's computing device 401 determines if an external wallet is present. If yes, the user's computing device 401 sends a request for credit card information to the external wallet in step 504. In step 505, the external wallet attempts to authenticate the merchant. For instance, the external wallet may determine whether the merchant is listed in a predetermined set of good merchants or bad merchants, or may attempt to authenticate credentials from the merchant has passed to the external wallet. For instance, an external wallet may attempt to check an online resource (for example, a Yellowpages™ or Whitepages™ listing) for information to authenticate the merchant.

Optionally, the external wallet may attempt to authenticate the user as well in step 507.

If the merchant has been authenticated in step 506 (as well as the user in step 507 if this step is used), then the external wallet may obtain a CVV in step 508. The external wallet may then forward the credit card information and CVV to merchant via path 406 in step 509. Finally, the external wallet may send generic content to display in the user's computing device 401's display screen via path 407 in step 510.

If the merchant (and/or user) was not authenticated in step 506, then the user's computing device may refused to release credit card information to the user and/or merchant in step 511.

Alternatively, if the merchant was not authenticated in step 506 (for example, no online listing available for the merchant) or if an external wallet is not present, then the user may attempt to use an internal secure wallet to obtain the credit card information and CVV in step 512. Here, the user's computing device 401 attempts to authenticate the user in step 513. If the user is authenticated from step 514, then the secure wallet obtains the credit card information and CVV in step 515. The secure wallet next sends the credit card information and CVV to the merchant via path 410. Next, the secure wallet since generic content to the display via path 409. Alternatively, from step 515, upon user request (and possible further authentication), the secure wallet displays credit card information and a CVV in display via path 409.

The user may then copy the information in display (from step 517) into a merchant's webpage or into forms for future credit card transactions.

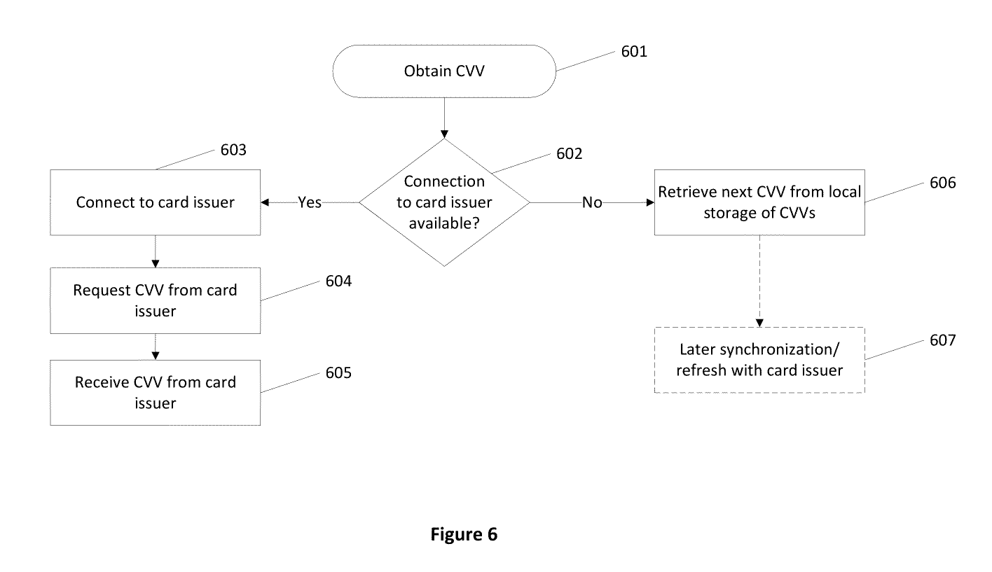

FIG. 6 shows various processes for obtaining a card verification value in accordance with one or more aspects. In step 601, a secure wallet (either internal or external) is requested to obtain credit card information including a CVV.

In a first example, the system determines if a connection to a card issuer is available in step 602 (the prior obtaining of the CVV may occur at an earlier time, when connectivity was available, and the current step 602 may occur at the next burst of connectivity). If yes, then the secure wallet connects to the card issuer in step 603. The secure wallet authenticates itself and the card issuer and requests a CVV in step 604. In step 605 the secure wallet receives the CVV from the card issuer and forwards it as described in FIG. 5.

If no connection to a card issuer is available in step 602, then the secure wallet obtains a stored CVV from a local storage of one or more CVVs in step 606 and forwards the CVV as described in FIG. 5. In some embodiments, the refresh and coordination with the card issuer can occur without connectivity, using similar CVV generation engines running at the issuing bank and the consumer's device (e.g., smart phone, PC, USB device, etc.).

Later, when the secure wallet is synchronized with the card issuer, used CVVs may be replaced with new CVVs as needed. Alternatively, all CVVs previously sent to the secure wallet may be replaced with new CVVs, irrespective of whether the previous CVVs were used in a transaction.

In a second example, a secure wallet may not determine if a connection to a card issuer is available as shown in step 602. Rather, a secure wallet may only obtain a CVV from its local storage of one or more CVVs.

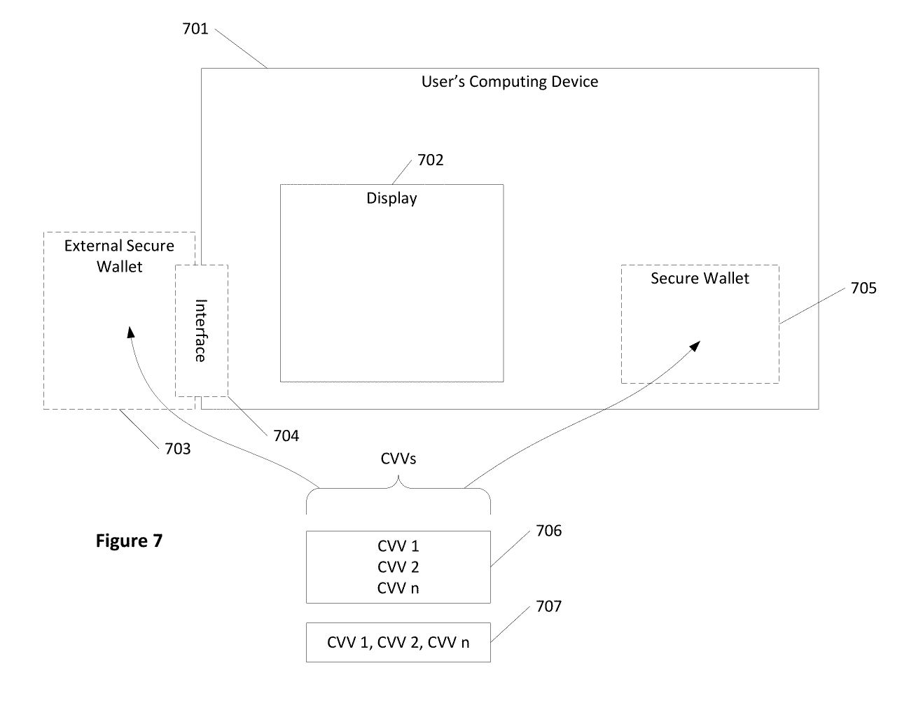

FIG. 7 shows various techniques of storing CVVs in one or more secure wallets. FIG. 7 includes a user's computing device 701 with a display 702. At least one of external secure wallet 703 (and interface 704) and internal secure wallet 705 is available to users computing device 701. CVVs may be stored as a list with individual entries as shown list 706. Alternatively, CVVs may be stored as a single string where each CVV is present as shown in string 707. The internal or external secure wallet may then parse the string 707 for the next (or random) CVV and provided as needed. Such a code-within-a-code may help reduce risk of man-in-the-middle attacks.

The features above are simply examples, and variations may be made as desired. For example, the CVV may be a static code assigned for the lifetime of a user's card. Alternatively, the CVV may be dynamically generated for each use of the card, different CVV codes can be generated for different transaction dollar values or limits, or for a predetermined duration of time (e.g., minutes, days, weeks, months, years, etc.).

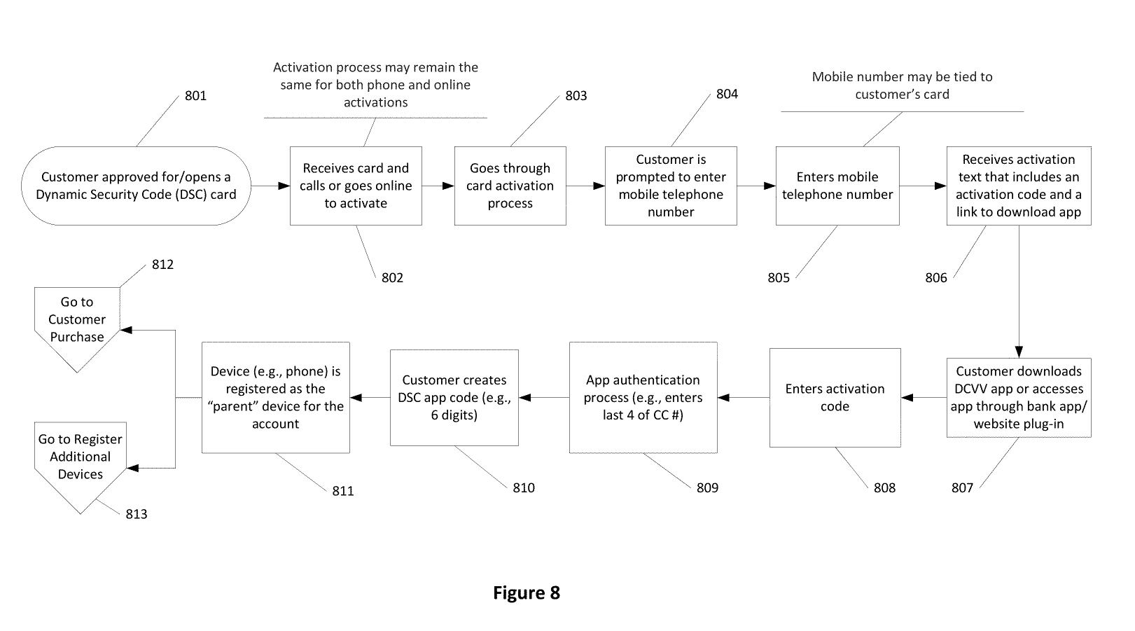

FIG. 8 shows a first card registration embodiment. In step 801, the customer is approved for and opens an account with a card issuer that provides cards with dynamic security codes (DSCs). In step 802, the customer receives the card and either calls the card issuer or logs in with the card issuer to activate the new card. Here, the activation process may be the same for both telephone and online activations. Next, in step 803, the user proceeds with the activation process. The activation process includes conventional questions from the card issuer and answers from the new cardholder to verify authenticity of the cardholder. For instance, the cardholder may need to provide his ZIP Code and/or home telephone number or other information as standard in the credit card industry.

In step 804, because the user is going to authenticate a mobile device to host and/or provide received DSCs, the user is prompted to enter a telephone number relating to the mobile device. In step 805, the user enters the mobile telephone number. For purposes of the card issuer, the user's telephone number will be associated with the user's new DSC-enabled card.

To activate the user's telephone number, the card issuer sends an activation text/instant message that includes an activation code. In one example, a link to download an application associated with the dynamic security code may be provided in the text message. In another example, a user may have previously downloaded an application for the mobile device and is authenticating the card through the application itself (for instance, by interacting with the application, the application sends the user's related information to the card issuer who then responds with an activation code/sequence/additional content provided directly to the application.

Next in step 807, the customer downloads the dynamic security code application for the mobile device. In another example, the customer may access the application through a conventional web browser and/or through the card issuers normal application running on the user's mobile device. In the example of using a conventional web browser, the web browser may be made additionally secure by downloading and installing an additional plug-in or converting to a secure communication exchange protocol (e.g., switching from “http:// . . . ” to “https:// . . . ”, a secure sockets layer SSL, public-private key encryption, or any other known security-enhancing technique).

Next, in step 808, the user enters the received activation code. In step 809, the application proceeds to conduct an authentication process to verify that the user has the new card present. This authentication process may include requesting the user to enter part or all of the credit card number, the expiration date, the name appearing on the card, a static CVV (if present), and/or other information relating to the physical card. In step 810, the customer creates and enters a code specific to the DSC application. This code is to permit the user to authenticate himself to the application.

In step 811, the device (e.g., the user's phone) is registered as the device associated with the user's card. In one example, the phone is registered as the parent device and is used to authenticate and/or register additional devices with the user's card.

While the term “telephone number” is used above, any other way of addressing information to the mobile device may be used including but not limited to IP address (including IPv4 and IPv6), MAC address for WiFi or Bluetooth or other wireless application protocol, serial number, IMEI, and ICCID and any other identifying information or code.

This may conclude the user's interaction with device for the time or the user may be provided with the options of proceeding with a customer purchase as shown in step 812 or to register additional devices as shown in step 813.

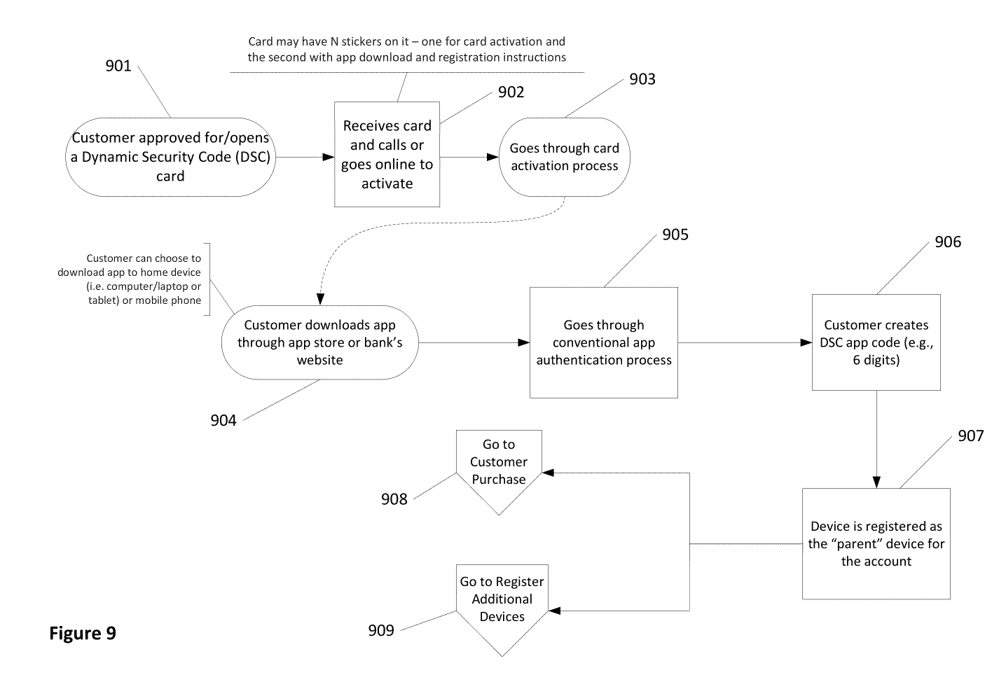

FIG. 9 shows a second card registration embodiment. In this second registration embodiment, the customer is approved/opens an account for a dynamic security code (DSC) card as shown in step 901. In step 902, the user receives the card and calls or goes online to activate it. The card may have one or more stickers on it such that one may be for card activation and the second with application download and registration instructions. In step 903, the user proceeds with the card activation process as described below. In step 904, the customer downloads an application through an online marketplace of available applications (e.g., the “App Store” in iTunes by Apple Inc. or equivalent) or through the card issuer's (e.g., bank's) website. In step 905, the user proceeds through a conventional application authentication process as described above. In step 906 the customer creates a DSC application code to be used to authenticate himself to the DSC application. In step 907, the device is registered as the device associated with the user's DSC-enabled card.

At this point, the user is presented with additional options including a proceeding to a customer purchase process as shown in step 908 or proceeding to register additional devices as shown in step 909.

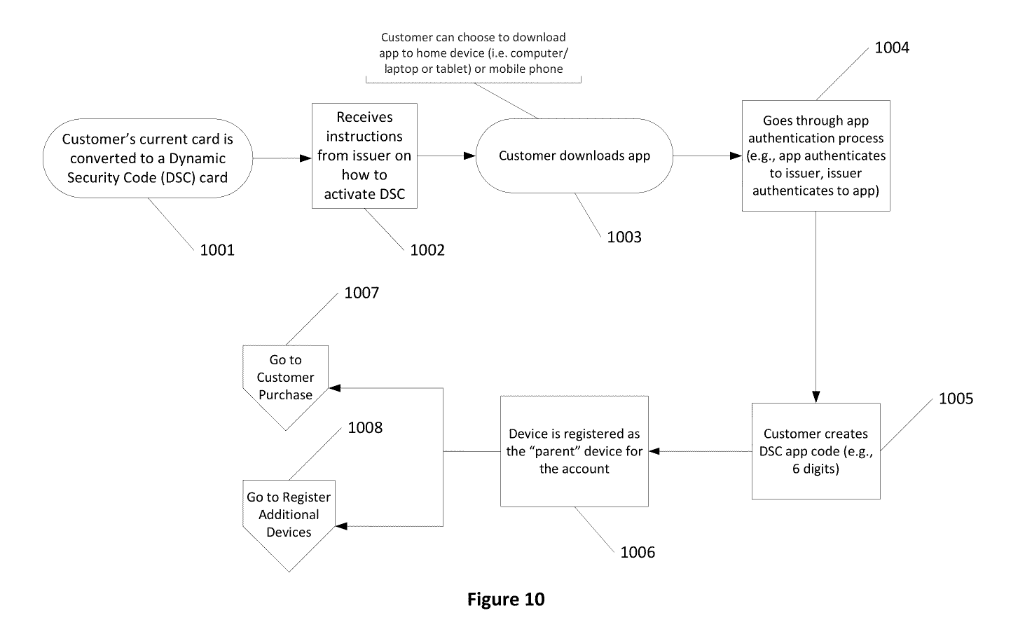

FIG. 10 shows a third card registration embodiment. In this third registration embodiment, a customer's current card is converted to a dynamic security code (DSC)-enabled card as shown in step 1001. In step 1002, the customer receives instructions from the card issuer on how to activate the DSC component of the user's card. In step 1003, the customer downloads the DSC application as described above. Here, the customer can choose to download the application to a home device (i.e., computer/laptop/tablet) or mobile phone or other mobile device.

In step 1004, the user proceeds through the authentication process (e.g., app authenticates to user and user authenticates to app) as described above. In step 1005, the customer creates a DSC-authentication code (for instance, six characters in length) and enters it into the app. Next, in step 1006, device is registered as the parent device for the DSC-enabled card and its associated account.

At this point, the user is presented with additional options including a proceeding to a customer purchase process as shown in step 1007 or proceeding to register additional devices as shown in step 1008.

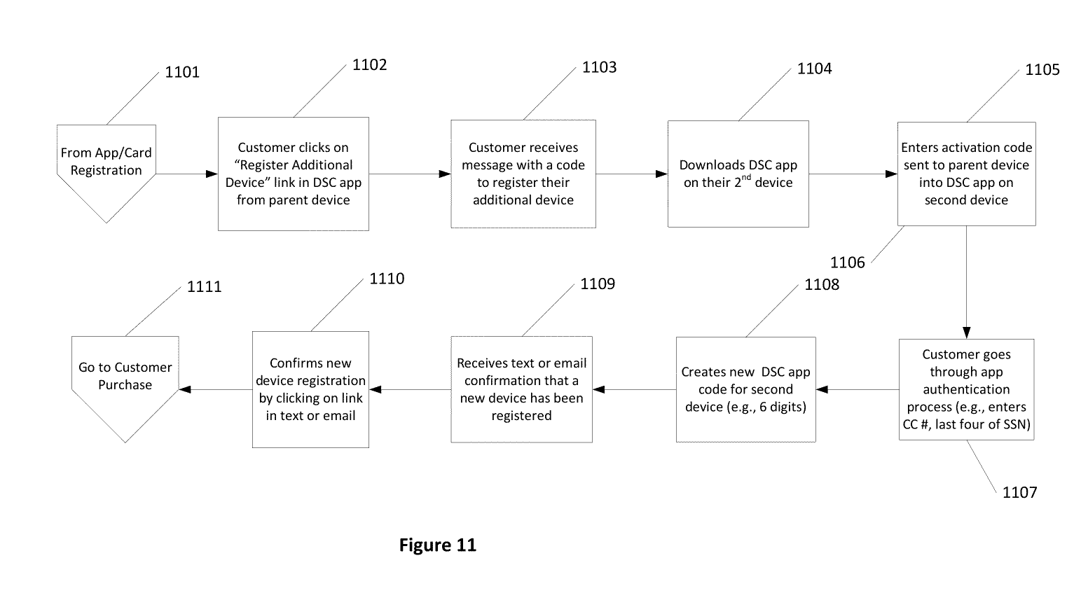

FIG. 11 shows a registration process of registering of additional devices with the

DSC-enabled card and associated account. In step 1101, the user indicates from the app/card registration processes of FIGS. 8-10 that additional devices need to be registered with the DSC-enabled card and associated account. These additional devices may be identified through another telephone number or one or more of the other identification information identified above (including IP addresses, etc.) or other information for identifying the additional devices.

In step 1102, the user in the DSC application selects or clicks on a “Register additional device” display element and associated link in the DSC application when interacting with the parent device. In step 1103, the customer receives a message with a code to register his additional device. In step 1104, the user downloads the DSC app to his second device/computer/laptop/tablet. In step 1105, the user receives via the parent device an activation code and enters it into the DSC app on the second device.

Next, in step 1107, the user proceeds with the DSC application authentication process as running on the second device (including entering information from the DSC-enabled card indicating the user has the DSC-enabled card present while interacting with the second device). The information entered may include the credit card number, the user's name as imprinted on the card, and/or other information relating to the physical card. Further, the user may authenticate himself to the app by using conventional information that identifies the user including but not limited to the last four digits of the user's Social Security number.

Next, in step 1108, the user creates a new DSC-application code for the second device. The new DSC-application code may include for instance six digits characters. It is appreciated that greater or fewer numbers of digits/characters may be used as desired.

In step 1109, the user may then receive a text or email confirmation that the new device has been registered. The text or email confirmation may be sent to one or both the parent device and the newly registered device and possibly included an additional warning that if this registration was made in error or not made on behalf of the cardholder to immediately contact the card issuer to address potential fraud-related issues. In step 1110, the user confirms the new device to registration by clicking on the link in the text or email. In one example, the card issuer may accept confirmation from either of the user's devices that the registration has proceeded satisfactorily. Alternatively, the card issuer may only accept confirmation from the parent device that the second device has been authorized. Further, for enhanced security, the card issuer may require confirmation from each of the user's devices.

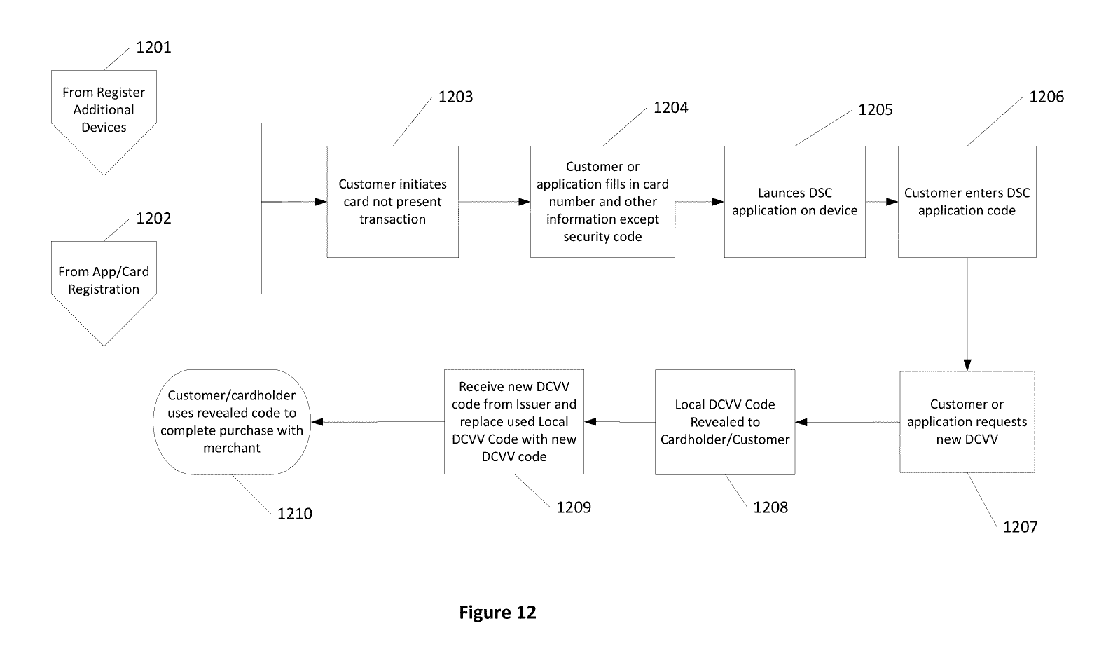

FIG. 12 shows a customer purchase embodiment in which a data connection is available between the cardholder and the card issuer. From the “register additional devices” process of step 1201 or from the “DSC application/card registration process” of step 1202, the customer initiates a purchase transaction as shown in step 1203. As there is no merchant to whom the customer can present his card via a magnetic strip or chip, this transaction is being processed as a card-not-present (CNP) transaction.

In step 1204, the customer (or the application with which the customer is shopping) fills in the user's credit card number and other information except the security code (CVV2). As shown in step 1205, the user launches the DSC application on the user's device. In step 1206, the user enters his DSC authentication code into the DSC application. In step 1207, the customer or the DSC application itself requests a new dynamic security code dCVV/DSC from the card issuer.

Next, in step 1208, one of the previously stored dynamic security codes is revealed to the customer in an effort to continuously attempt to cycle through the stored dynamic security codes on the user's device. This is shown in step 1209 where the newly received the dynamic security code from the card issuer replaces (or, for example, is appended to the list of dynamic security codes stored in the local device) and the dynamic security code displayed to the user is recorded as having been used.

Finally, in step 1210, the customer uses the revealed dynamic security code to complete the purchase with the merchant.

This process of FIG. 12 may be useful when the customer desires to complete the transaction before the new DSC is received. It is appreciated that a network connection between the DSC app on the user's device and the card issuer may not always be available to the customer when making the purchase but shortly thereafter. Accordingly, the dynamic security code revealed to the customer may be one of the previously stored dynamic security codes.

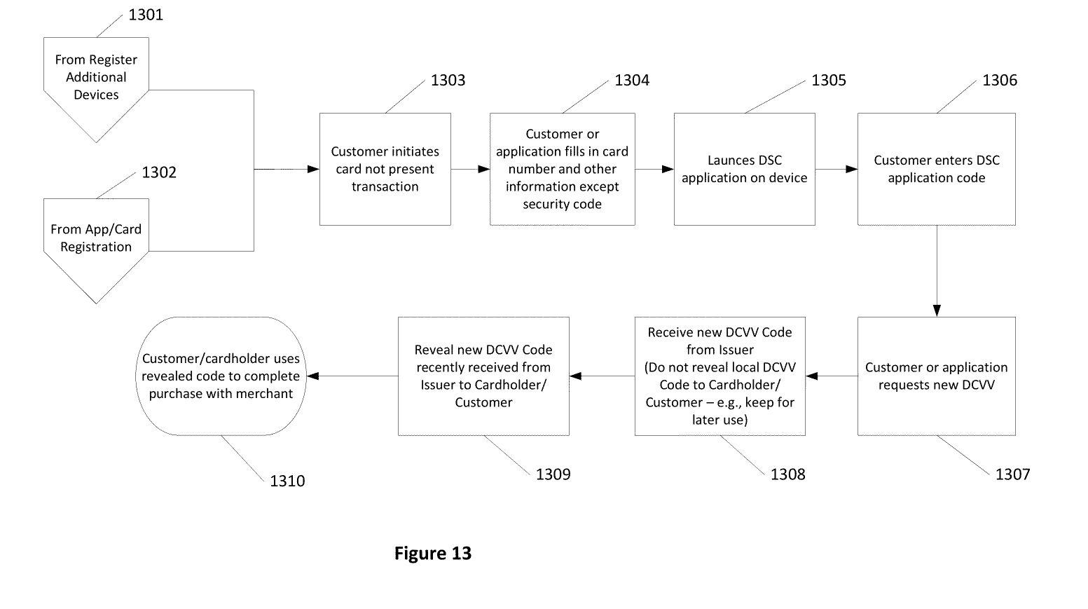

FIG. 13 shows another customer purchase embodiment in which a data connection is available between the cardholder and the card issuer. From the “register additional devices” process of step 1301 or from the “DSC application/card registration” process of step 1302, the customer initiates a purchase transaction as shown in step 1303. As there is no merchant to whom the customer can present his card via a magnetic strip or chip, this transaction is being processed as a card-not-present (CNP) transaction.

In step 1304, the customer (or the application with which the customer is shopping) fills in the user's credit card number and other information except the security code (CVV2). As shown in step 1305, the user launches the DSC application on the user's device. In step 1306, the user enters his DSC authentication code into the DSC application. In step 1307, the customer or the DSC application itself requests a new dynamic security code dCVV/DSC from the card issuer.

Next, in step 1308, a new dynamic security code is received by the customer and revealed to the customer in step 1309. Finally, in step 1310, the customer uses the revealed dynamic security code to complete the purchase with the merchant.

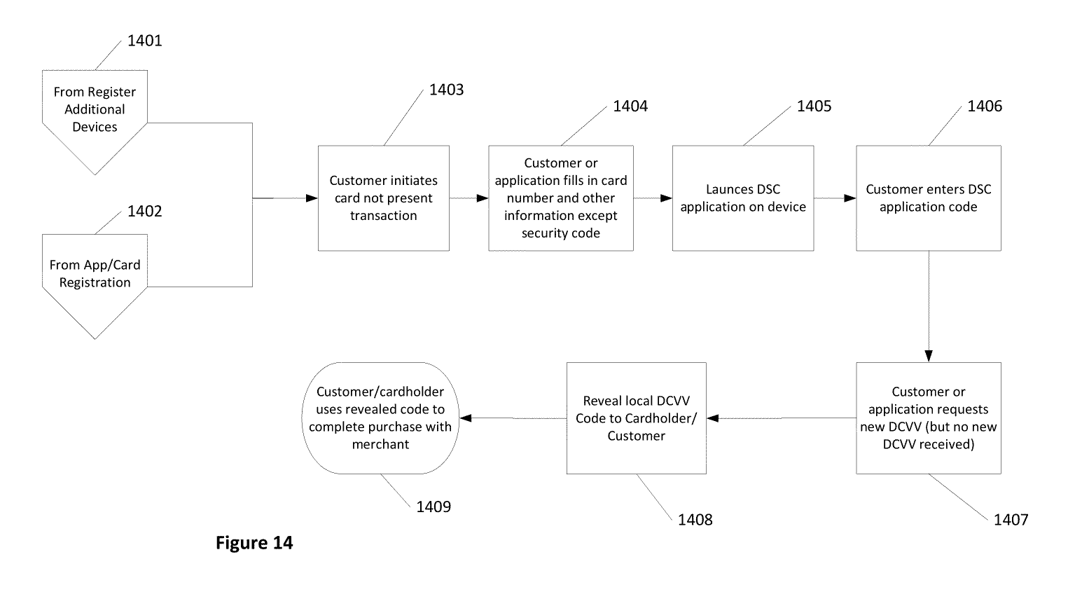

FIG. 14 shows a customer purchase embodiment in which a data connection is not available between the cardholder and the card issuer. From the register additional devices process of step 1401 or from the DSC application/card registration process of step 1402, the customer initiates a purchase transaction as shown in step 1403. As there is no merchant to whom the customer can present his card via a magnetic strip or chip, this transaction is being processed as a card-not-present (CNP) transaction.

In step 1404, the customer (or the application with which the customer is shopping) fills in the user's credit card number and other information except the security code (CVV2). As shown in step 1405, the user launches the DSC application on the user's device. In step 1406, the user enters his DSC authentication code into the DSC application. In step 1407, the customer or the DSC application itself requests a new dynamic security code dCVV/DSC from the card issuer. However, because no network connection is available, no new DSC is received.

Next, in step 1408, one of the previously stored dynamic security codes is revealed to the customer and indicated in the storage of the mobile device as having been used. Finally, in step 1409, the customer uses the revealed dynamic security code to complete the purchase with the merchant.

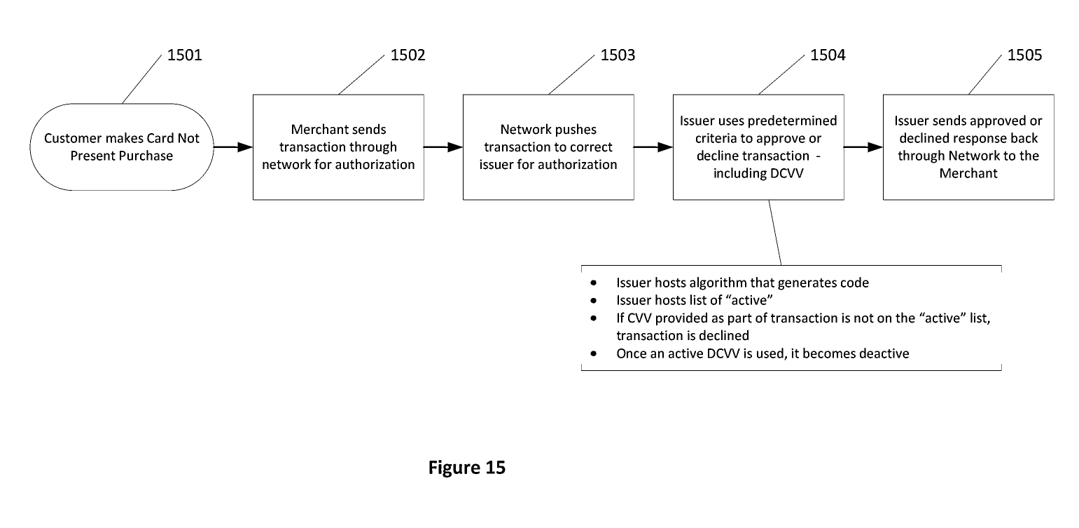

FIG. 15 shows an embodiment where the card issuer hosts a list of or an algorithm generating active dynamic security codes to complete a purchase transaction using a card having a dynamic security code. As shown in step 1501, a user makes a card-not-present transaction for example shown above with respect to FIGS. 12-14. In step 1502, the merchant sends the transaction through the network for authorization.

The term “network” between the merchant and the card issuer may include the Internet or other networks related to the credit processing infrastructure. For instance, the networks may include a private network or Internet-using network in which transactions are handled. For instance the network may include the MasterCard and Visa interchange networks or may include networks integrated with card issuers including those provided by American Express and Discover card services.

In step 1503 the network identifies the card issuer from the transaction information (e.g., the personal account number/credit card number received by the merchant) and forwards the transaction to the correct issuer for authorization of the transaction. The issuer may use predetermined criteria as known in the art (including an indication whether the credit card number has been stolen, a determination that the transaction amount is within the customers spending limits, that the expiration date is valid, and other conventional information) to identify that the transaction is legitimate. Further, as shown in step 1504, the issuer may use the received dynamic security code to further authenticate the transaction. For instance, the issuer may host an algorithm that generates the dynamic security code in addition to a list of active dynamic security codes as previously been provided to the cardholder (including to the DSC application executing on the user's mobile device).

As shown in step 1505, if the CVV provided as part of the transaction received from the merchant is on the list of active dynamic security codes, and the remaining information received from the merchant indicates the transaction is authentic, then the transaction may be approved. If the CVV provided as part of the transaction received from the merchant is not on the list of active dynamic security codes, then the transaction may be declined by the card issuer. Alternatively, the card issuer may still approve the transaction based on other qualifying criteria despite the dynamic security code having been previously used or not on the list of active dynamic security codes.

As shown in step 1505, the issuer sends the approved or declined response back through the network to the merchant.

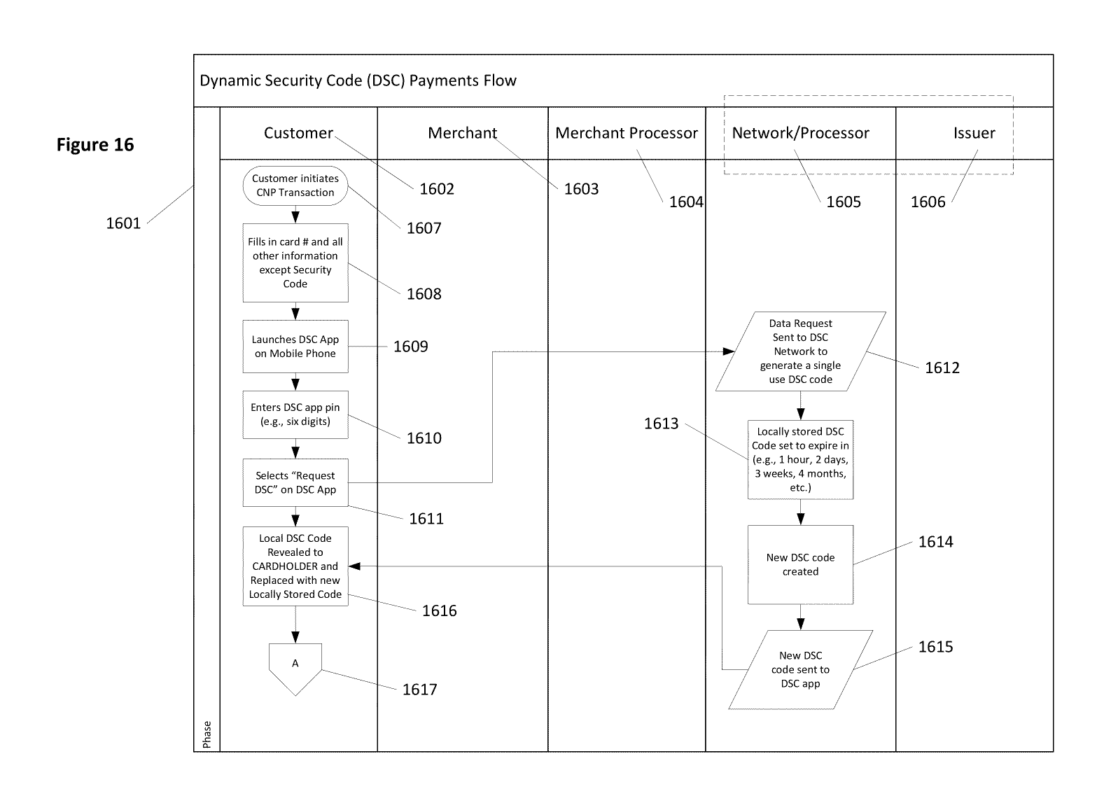

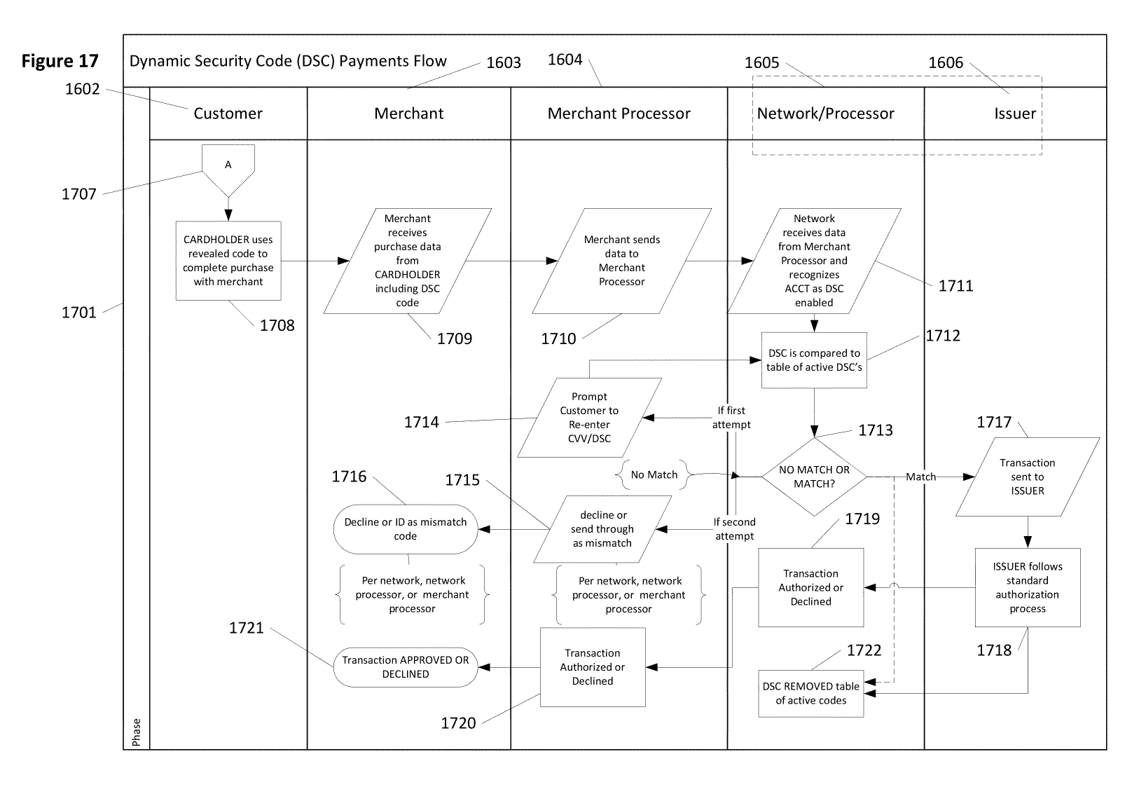

FIGS. 16-17 show an example of payment processing using a dynamic security code in two parts. In FIG. 16, the first part of a dynamic security code payment flow 1601 is shown. The second part is described in relation to FIG. 17. FIG. 16 shows operations performed by a customer 1602, merchant 1603, merchant processor 1604, a network processor 1605, and a card issuer 1606. As shown by the dotted box surrounding network processor 1605 and issuer 1606, these may be combined into a single entity. As known in the art, each of these entities of FIG. 16 includes at least one processing device, input/output communication pathways, and various data storage capabilities.

In step 1607, the customer initiates a card-not-present transaction. In step 1608, the customer fills in the card number and other information except for the dynamic security code. In step 1609, the customer launches the dynamic security code application on the user's mobile device. In step 1610, the user authenticates himself to the DSC-application using the DSC-authentication code. In step 1611, the user or the device initiates a request to the network processor 1605 and/or issuer 1606 for a new dynamic security code. In step 1612, the network processor 1605 receives the request to generate a single-use dynamic security code. In step 1613, the network processor 1605 determines when new dynamic security codes stored with the network processor 1605 are set to expire (for instance, within one hour, a few days, a few weeks or a few months). In step 1614, the network processor 1605 generates the new dynamic security code and stores it with an expiration date. In step 1615, the new dynamic security code is sent back to the DSC application running on the user's device. The new dynamic security code is received in step 1616 at the user's local device. The remaining portion of this payment processing continues with step 1617/1707.

In FIG. 17, at step 1707, the process continues from FIG. 16. In step 1708, the customer uses the revealed DSC to complete the purchase with the merchant. In step 1709, the merchant receives purchase data from the customer including the DSC code. The merchant 1603 has its transactions cleared by the merchant processor 1604. The merchant 1603 may be integrated with the merchant processor 1604 or separate from the merchant processor 1604 where the merchant processor 1604's services are provided for a number of different merchants 1603. In step 1710, the merchant processor 1604 receives the data sent from merchant 1603. In step 1711, network processor 1605 receives data from the merchant processor 1604 and recognizes the account as a DSC-enabled card. This recognition may be based on a lookup table of specific DSC-enabled/DSC-not enabled cards, a specific card issuer, a specific series of PANs (personal account numbers) and the like.

In step 1712, the received DSC is compared to a table of active DSCs stored with the network processor 1705. Alternatively, the table of active DSC's may be stored with issuer 1606.

In step 1713, it is determined if the received DSC is a match with the active DSC's in the table. If there is no match and it is the first attempt, then in step 1714, this information is relayed to the merchant processor which then prompts customer to reenter the CVV/DSC and the newly received DSC is compared again in step 1712. If there is no match and it is the second attempt, then in step 1715, the merchant processor declines the transaction or sends the transaction on as having been a mismatch in that the information received from the customer does not comport with identification information available to the network processor. Next, in step 1716, the merchant may decline the transaction or identify the transaction as a mismatch and, depending on the merchant's internal policy, accept or continue to decline the transaction with the customer 1602.

If a match from step 1713, the transaction is sent to the issuer 1606 in step 1717. In step 1718, the issuer follows its standard authorization process (including verifying other information relating to the transaction for authenticity—e.g., evaluating history of the merchant, history of the card (stolen/not stolen/active fraud alert), time of the transaction, date of the transaction, amount of the transaction, etc.). The issuer then authorizes or declines the transaction in step 1719 as forwarded through the network processor, merchant processor (as 1720) and to the merchant where the merchant indicates to the customer that the transaction is approved or declined (in step 1720).

Here, the process of FIG. 17 puts the DSC matching operations in the network before the purchase information reaches the card issuer.

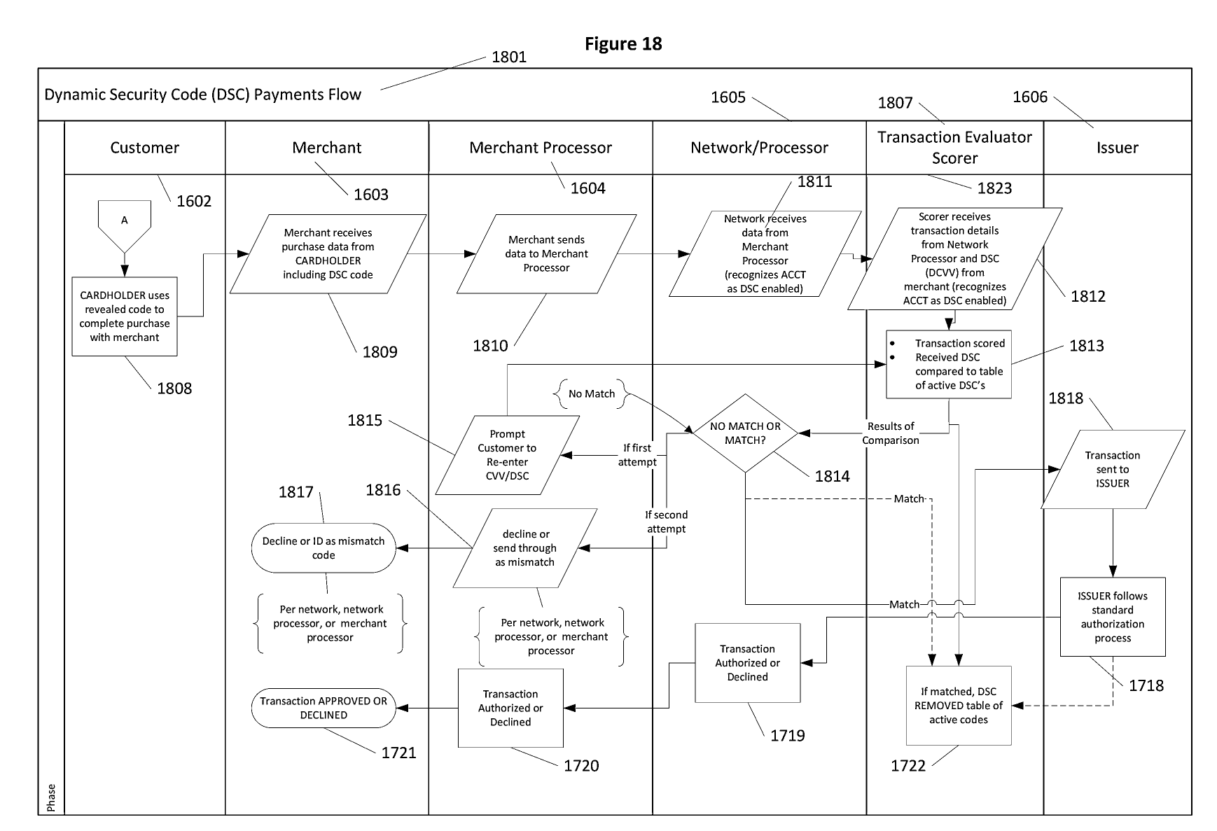

FIG. 18 shows a modification of the payment processing of FIG. 17 as using a transaction evaluator/scorer. FIG. 18 shows an alternative to the process of FIG. 17. In step 1808, the cardholder uses the revealed DSC to complete the purchase with the merchant. In step 1809, the merchant receives purchase data from the cardholder including the DSC code. In step 1810, the merchant sends the transaction data to the merchant processor. In step 1811, the network processor receives the data from the merchant processor and recognizes the account as DSC-enabled.

In FIG. 18, a transaction evaluator/scorer 1807 receives the transaction details in step 1812 from the network processor and the DSC from the merchant. Here, if the account has not already been recognized as a DSC-enabled account, it may be recognized as such by the transaction evaluator/scorer 1807.

The transaction evaluator/scorer 1807 is known in the art as an entity providing an extra level of security to card issuers by scoring transactions. A non-limiting example of the transaction evaluator/scorer 1807 is the FICO™ FALCON™ credit scoring platform provided by the Fair Isaac Corporation.

Here the transaction evaluator/scorer 1807 performs the checking of the DSCs. Specifically, in step 1813, the transaction is scored (as is performed by the conventional FICO Falcon credit scoring platform) and the received DSC is compared to a table of active DSCs resident with the transaction evaluator/scorer 1807. Next, the result of the scoring of the transaction and the comparison of the received DSC to the list of active DSC's is shown as a match/no match decision in step 1814. If there is a match with the DSCs, the transaction is forwarded to the card issuer in step 1818 and the issuer follows it standard authorization process in step 1819 as described above.

If there is a match between the received DSC and the list of active DSC's, the table of active DSC's may be updated to remove the received DSC and add a new one (with the new DSC forwarded to the customer at the time of the transaction or thereafter) as shown in step 1825. That updating of the table of DSC's may also or alternatively occur after step 1814 or after step 1819.

After the issuer follows its standard authorization process of step 1819, the authorized declined status of the transaction is provided to network processor 1605 at step 1820, to the merchant processor 1604 at step 1821, and to the merchant as step 1822.

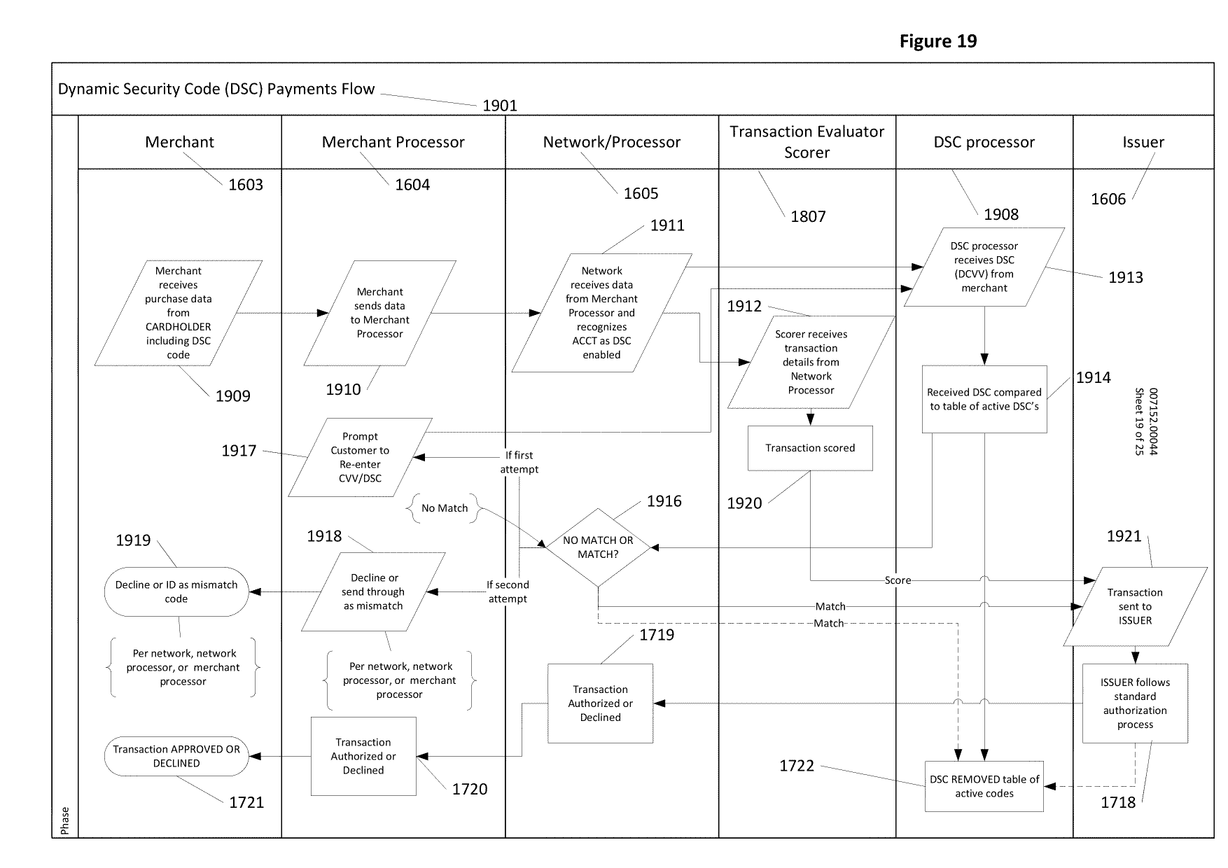

FIG. 19 shows another modification of the payment processing of FIG. 17 as including a DSC processor that manages the DSCs. FIG. 19 includes another example of a payment flow in which a separate dynamic security code evaluation entity is provided to specifically evaluate the received DSC. The DSC processor 1908 may be a server or collection of servers that receive the DSC from the merchant, compare the received DSC with a stored list of DSC's and provide the information to the transaction evaluator scorer 1807 and/or card issuer 1606.

Specifically, in step 1909, the merchant receives purchase data from the cardholder including the DSC code. In step 1910, the merchant processor receives transaction data from the merchant. In step 1911, the transaction evaluator scorer 1807 receives transaction details from the network processor 1605 and the transaction is scored in step 1920 with the score being forwarded to the issuer in step 1921.

Also, the DSC processor 1908 receives the DSC from the merchant in step 1913. The received DSC is compared to a table of active DSC's in step 1914. If a match occurs between the received DSC and the list of active DSC's, then the DSC is removed from the table of active DSC's and replaced with a newly generated in step 1722 (and the new DSC forwarded to the cardholder at that time or thereafter).

In step 1916, is determined whether the received DSC is a match or not a match with the stored list of DSC's. If not a match and the first attempt, the customer is prompted to reenter the DSC in step 1917 and the reentered DSC is evaluated in step 1913.

If the second attempt, then the transaction is declined by the merchant processor in step 1918 or identified as a mismatch and sent to the merchant in step 1919.

If a match from step 1916, this information is sent to the card issuer as part of step 1921 where the issuer continues with its standard authorization process in step 1718 with the results provided back to the merchant via steps 1719, 1720, and 1721.

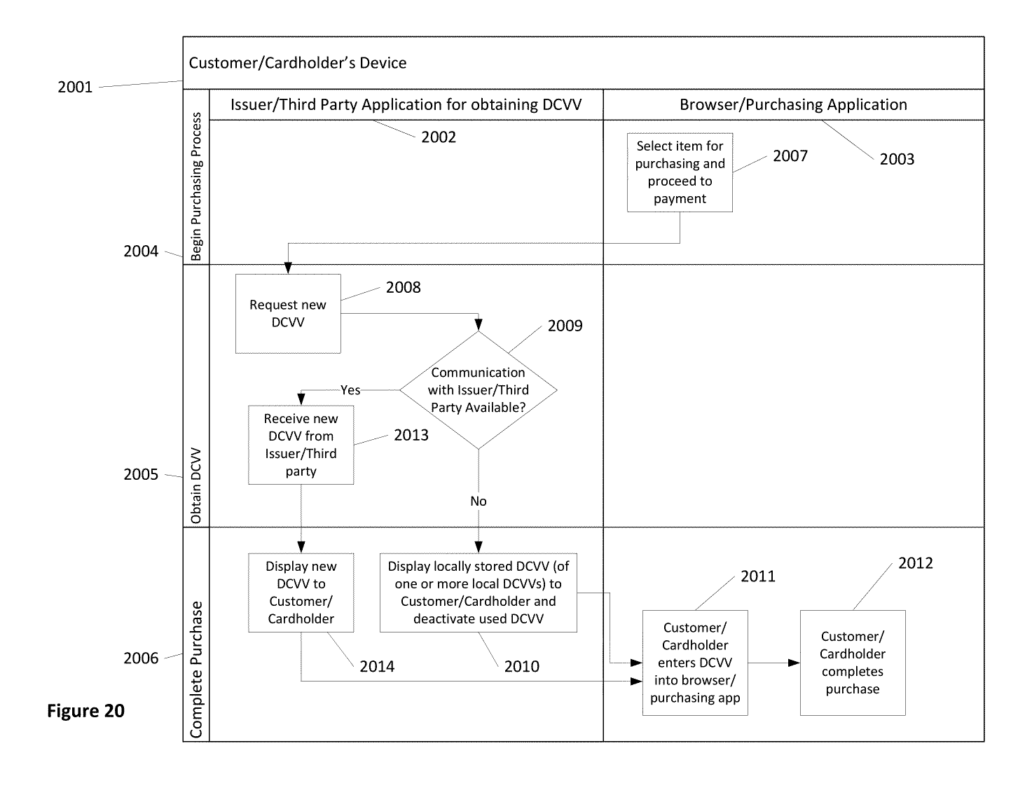

FIG. 20 shows an embodiment related to the payment handling of a dynamic security code of FIGS. 13 and 14. FIG. 20 shows payment handling from the perspective of the customer's device 2001. FIG. 20 shows a first column relating to the issuer/third-party application for obtaining the DCVV 2002 running on the user's device. and a second column relating to a browser/purchasing application 2003 running on the user's device.

Also, FIG. 20 is separated into rows including a beginning of the purchasing process 2004, obtaining the DCVV 2005, and completing the purchase 2006.

In step 2007, the user selects the item for purchase and proceeds to payment in the browser/purchasing application 2003.

The issuer/third-party application 2002 monitors the browser purchasing application 2003 and detects the purchasing page including for instance a space into which occur to card number may be entered. For instance, the detection of the field in the browser/purchasing application 2003 may be based on metadata or other information stored with the field to receive the credit card information being detected by the issuer/third-party application 2002. Alternatively, the issuer/third-party application 2002 may detect specific keywords or graphics pertaining to credit cards and/or payment information as is known in the art.

In step 2008, the issuer/third-party application 2002 detects the payment processing page from the browser/purchasing application 2003 and requests a new DCVV. The issuer/third-party application 2002 determines if communication with the issuer/third-party is available in step 2009 (for instance, via a cellular, WiFi, DSL, Cable, fiberoptic, Bluetooth, LAN, WAN—type connections and the like). If the connection is available and the request is made to the issuer/third-party, the new DCVV is received in step 2013. Next, in step 2014, the issuer/third-party application 2002 obtains the new DCVV.

If no communication with the issuer/third-party is available, then the user's device continues with the stored list of DSCs and obtains a locally stored DCVV of one or more locally stored DCVVs to the customer/cardholder and deactivates (or indicates as used) the DCVV in step 2010.

In steps 2010 and 2014, the selected DCVV is displayed to the user who then enters it in step 2011 into the browser purchasing app and completes the purchase in step 2012.

Alternatively, the issuer/third-party application 2002, once obtaining the selected DCVV in either of steps 2010 or 2014, may enter it into the purchasing app 2011 directly without the user needing to copy and reenter the DCVV.

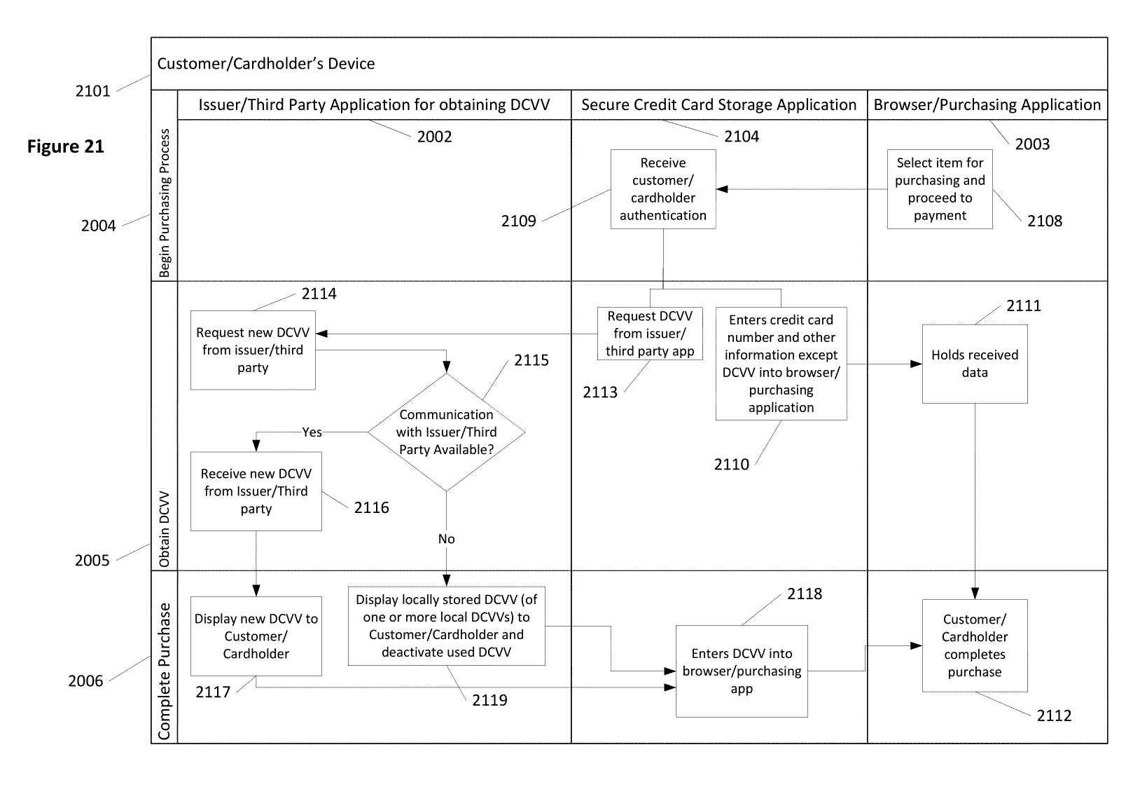

FIG. 21 shows an embodiment related to the payment handling of a dynamic security code. FIG. 21 is similar to that of FIG. 20 but also includes a secure credit card storage application 2103. The secure credit card storage application may include a separate/partitioned storage of the user's device that has its own level of encryption and to which the user may need to be separately authenticated.

In step 2108, the user selects an item for purchasing and proceeds to payment in the browser/purchasing application 2003. In the secure credit card storage application 2104, in step 2109 the customer/cardholder's authentication is requested and received to authenticate the customer/cardholder to the secure credit card storage application 2104.

The secure credit card storage application 2104 requests the DCVV from the issuer third-party app as shown in step 2113 and begins to enter credit card information (except the DCVV) into the browser purchasing application in step 2110. The browser purchasing application in step 2111 holds the received data from the secure credit card storage application 2104.

In step 2114, the issuer/third-party application 2002 requests a new DCVV from the card issuer/third party. The issuer/third-party application 2002 determines if communication with the issuer/third-party is available in step 2115 (for instance, via a cellular, WiFi, DSL, Cable, fiberoptic, Bluetooth, LAN, WAN—type connections and the like). If the connection is available and the request is made to the issuer/third-party, the new DCVV is received in step 2116. Next, in step 2117, the issuer/third-party application 2002 obtains the new DCVV.

If no communication with the issuer/third-party is available, then the user's device continues with the stored list of DSCs and obtains a locally stored DCVV of one or more locally stored DCVVs to the customer/cardholder and deactivates (or indicates as used) the DCVV in step 2119.

The selected DCVV is provided to the secure credit card storage application 2104 which then enters the received DCVV into the browser/purchasing app 2003 in step 2118 and the user completes the purchase in step 2112.

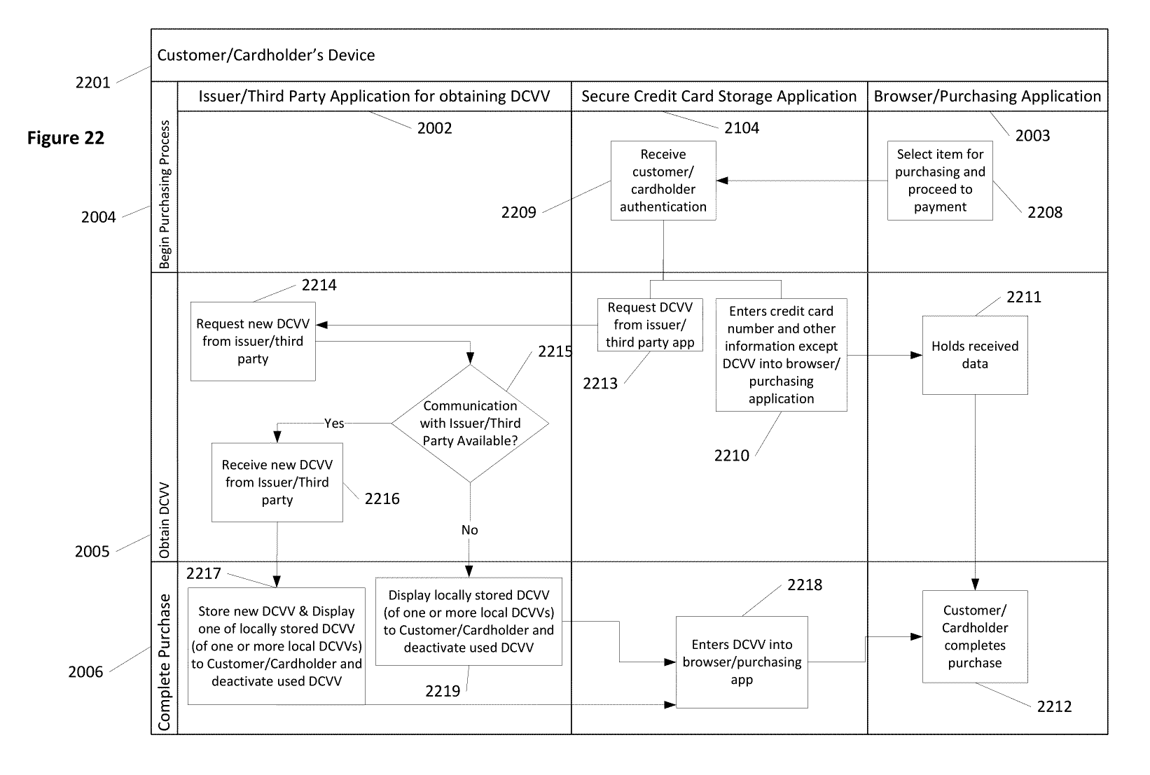

FIG. 22 shows another embodiment related to the payment handling of a dynamic security code. FIG. 22 shows a further embodiment related to the payment handling of a dynamic security code. FIG. 22 is similar to that of FIG. 21 but also includes using a stored DCVV before using a new DCVV received from the issuer/third party.

In step 2208, the user selects an item for purchasing and proceeds to payment in the browser/purchasing application 2003. In the secure credit card storage application 2104, in step 2209 the customer/cardholder's authentication is requested and received to authenticate the customer/cardholder to the secure credit card storage application 2104.

The secure credit card storage application 2104 requests the DCVV from the issuer third-party app as shown in step 2213 and begins to enter credit card information (except the DCVV) into the browser purchasing application in step 2210. The browser purchasing application in step 2211 holds the received data from the secure credit card storage application 2104.

In step 2214, the issuer/third-party application 2002 requests a new DCVV from the card issuer/third party. The issuer/third-party application 2002 determines if communication with the issuer/third-party is available in step 2215 (for instance, via a cellular, WiFi, DSL, Cable, fiberoptic, Bluetooth, LAN, WAN—type connections and the like). If the connection is available and the request is made to the issuer/third-party, the new DCVV is received in step 2216. Next, in step 2217, the issuer/third-party application 2002 obtains the new DCVV. That new DCVV is stored and one of the previously stored DCVV's is used for the current transaction. The new DCVV is added to the list of stored active DCVVs and the DCVV used for the current transasction is marked as used (and/or deleted).

If no communication with the issuer/third-party is available, then the user's device continues with the stored list of DSCs and obtains a locally stored DCVV of one or more locally stored DCVVs to the customer/cardholder and deactivates (or indicates as used) the DCVV in step 2219.

The selected DCVV is provided to the secure credit card storage application 2104 which then enters the received DCVV into the browser/purchasing app 2003 in step 2218 and the user completes the purchase in step 2212.

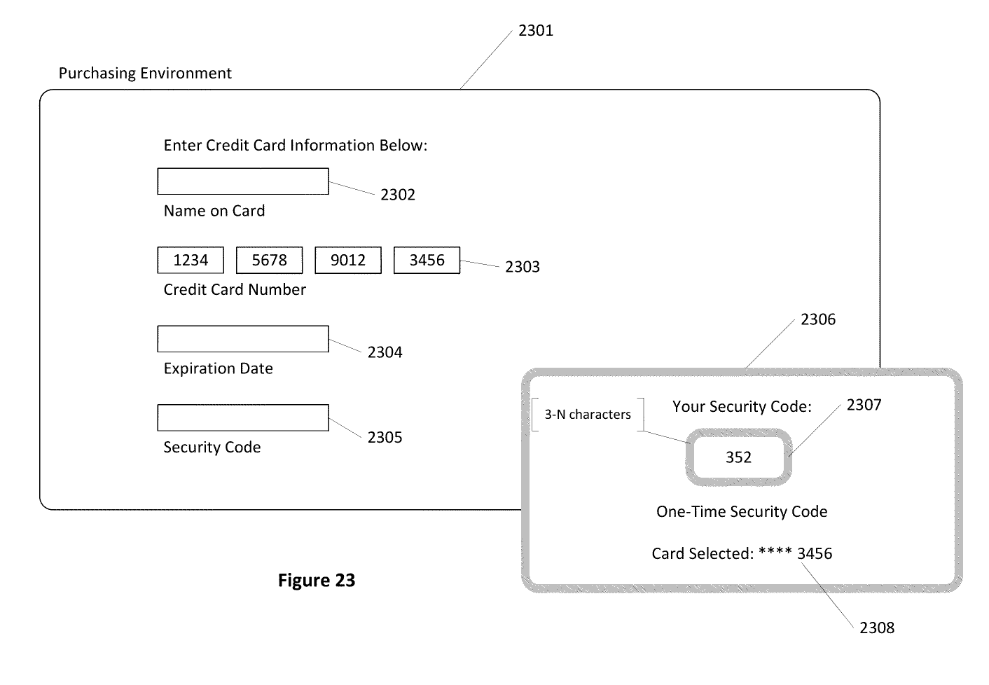

FIG. 23 shows a customer purchasing experience in which the dynamic security code is displayed to the customer/card holder. FIG. 23 shows a screen displayable on a user's device pertaining to a purchasing environment including a field 2302 in which to receive the name as imprinted on the card, field 2303 in which to receive a credit card number (a.k.a., a personal account number PAN), field 2304 in which to receive an expiration date, and field 2305 in which to receive a security code. Upon activation of the DSC-application, the user is presented with an overlay shown as content 2306 identifying the user's security code in field 2307. The length of the security code may be dependent on the requirements of the card issuer (e.g. MasterCard and Visa requiring security codes of three digits while American Express requires security codes of four digits).

Further the last four digits of the selected card may be displayed in field 2308 so as to provide a visual reference between the displayed DSC in field 2307 and the card identified in field

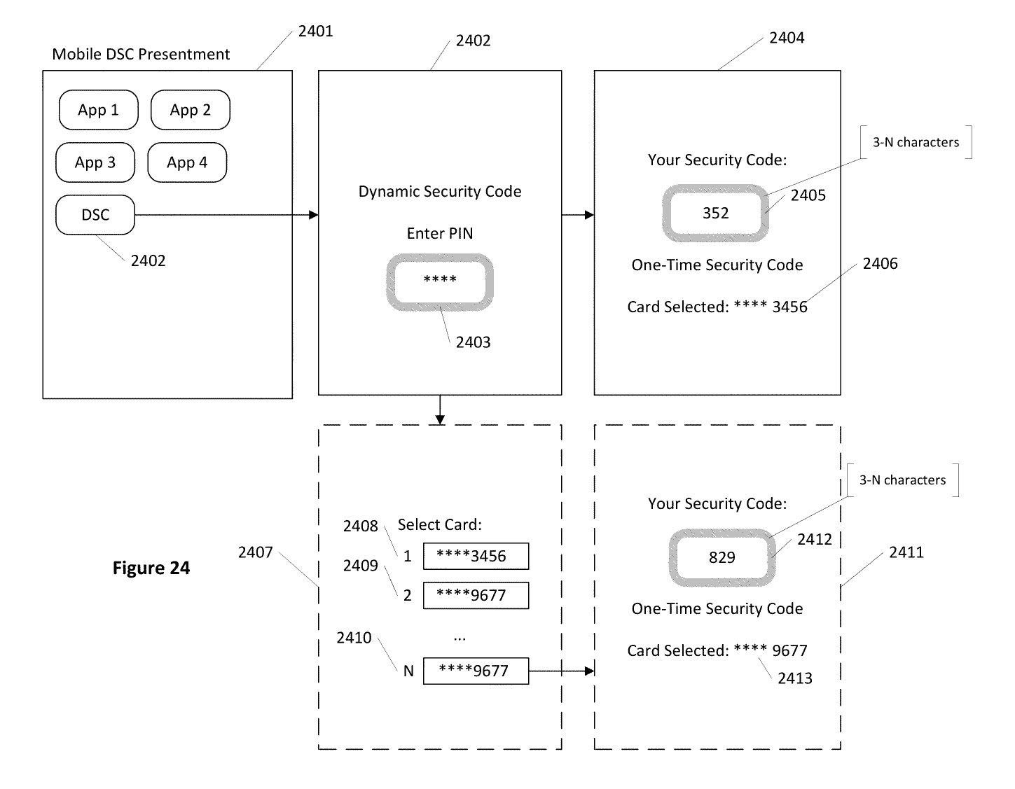

FIG. 24 shows another customer purchasing experience in which the dynamic security code is displayed to the customer/card holder in which the dynamic security code varies by selected card. Display 2401 shows an illustrative top-level screen of a user's device that includes identifiers pertaining to five applications of which one of them is the DSC-application 2402. Upon selection of the DSC-application 2402, the user authenticates himself to the application entering the DSC-authentication code in field 2403 in screen 2402. Next on screen 2404, the DSC-application 2402 displays the security code in field 2405 and also displays the last four digits of the selected card in field 2406.

If the user has multiple cards with which DSC's are enabled, the user may be presented with screen 2407 where the user is prompted to select one of the cards identified by the last four digits or other identifying information (e.g., name of the card, card issuer, or other related nicknames for the card) in fields 2408-2410.

Next, once the user has selected a specific card, the user is presented with screen 2411 that includes the security code 2412 with the confirmation of the card number 2413.

Is appreciated that the identification of the card in field 2413 and field 2308 may be eliminated as desired because this information pertains to confirming the identity of the card to the user. As the user may not need this subsequent confirmation, the identification of the card in fields 2413 and 2308 may be eliminated.

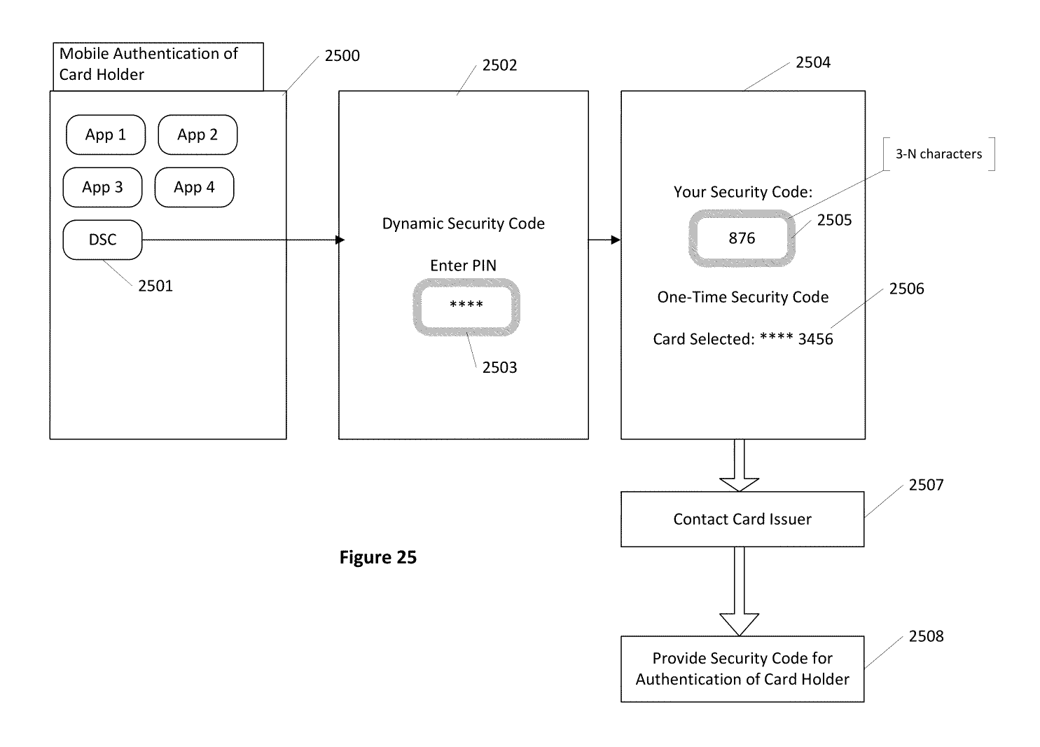

FIG. 25 shows a customer authenticating experience in which the dynamic security code is displayed to the customer/card holder to authenticate the user to the card issuer (for instance when calling or logging into the card issuer's website. Display 2500 provides displayed icons with embedded links to a number of apps including DSC-application 2501. Display 2502 includes a field 2503 in which a user authenticates himself to the DSC application via entering the DSC authentication code.

Display 2504 includes the display of the user's security code in field 2505 and with an optional identification of the card selected in field 2506.

As shown in step 2507, the user may then contact the card issuer and authenticate himself with the security code identified in field 2505. Alternatively, the user may contact the card issuer prior to logging into the DSC application 2502 or after having logged into the application but before obtaining the dynamic security code.

Finally, the user provides the dynamic security code to the card issuer to authenticate himself to the card issuer in step 2508.

It is appreciated that, instead of using lookup tables of stored dynamic security codes at the card issuer, DSC evaluator, or any of the transaction processors or transaction scoring entities, the dynamic security codes may instead not be stored but instead may be provided as algorithmic comparisons based on the received dynamic security code from the cardholder along with the PAN, expiration date, and other varying information including the transaction date, the week of the transaction, the time of the transaction, the monthly transaction, and the like.

We claim:

1. An external secure wallet comprising:
a processor;
a memory configured to store a plurality of stored card verification values received from a card issuer; and
an interface configured to be connected to a user's computing device,
wherein said processor is configured to receive user input from the user's computing device and authenticate that the user is an authorized user of the external secure wallet, and
wherein, upon authentication of the user, the processor obtains a card verification value from the memory and forwards the card verification value to the user's computing device via said interface.

2. An internal secure wallet in a user's computing device comprising:
a secure memory configured to store a plurality of stored card verification values received from a card issuer; and
a processor configured to encrypt and decrypt information as being exchanged with the secure memory,
wherein said processor is configured to receive user input from the user's computing device and authenticate that the user is an authorized user of the internal secure wallet, and
wherein, upon authentication of the user, the processor obtains a card verification value from the secure memory and forwards the card verification value to one of a display region on a display device of the user's computing device and to a communication interface of the user's computing device.
